(19) United States
(12) Patent Application Publication
(10) Pub. No.: US 2016/0132905 A1
(43) Pub. Date: May 12, 2016

(54) SYSTEM FOR MEASURING AUDIENCE RECEPTION TOWARDS ARTISTS AND FOR DIRECTING RESOURCES TO ARTISTS BASED UPON THEIR MEASURED AUDIENCE RECEPTION

(71) Applicant: INNOVENTIONS HOLDINGS, LLC, Alpharetta, GA (US)

(72) Inventors: Kerwin RICHARDS, Alpharetta, GA (US); Kurtis RICHARDS, Alpharetta, GA (US)

(73) Assignee: INNOVENTIONS HOLDINGS, LLC, Alpharetta, GA (US)

(21) Appl. No.: 14/930,246

(22) Filed: Nov. 2, 2015

Related U.S. Application Data
(60) Provisional application No. 62/073,897, filed on Oct. 31, 2014.

(51) Int. Cl. G06Q 30/02; G06Q 50/00; G06F 17/30; G06N 5/04; G06Q 10/06

(52) U.S. Cl. CPC G06Q 30/0201; G06N 5/048; G06Q 10/06313; G06F 17/3053; G06F 17/30528; G06F 17/30867; G06Q 50/01

(57) ABSTRACT

A computer system for directing resources to artists based upon a generated artist's score, including a score generating computer system with both quantitative and qualitative assessment modules for selecting artist peer groups, receiving and analyzing qualitative evaluations of audience reaction to artistic performances, receiving quantitative data sets representing quantitative data corresponding to the artistic performances, and calculating artistic scores for individual artists which are then transmitted both to the artists and to creative promotors to direct resources to preferred high scoring artists.

### RELATED APPLICATION

The present application claims priority to U.S. Provisional patent application 62/073,897, entitled “Perception Analyses Systems And Methods” filed Oct. 31, 2014, the entire disclosure of which is incorporated herein by reference in its entirety for all purposes.

### TECHNICAL FIELD

The present invention is related to systems that measure, quantify and score audience reactions to artists and other performers such that the resources of artistic promoters can be directed to higher rated artists and performers based upon the scores of audience reaction to their artistic works.

### BACKGROUND

There are over 1 million registered musical artists in the United States. When this number is coupled with unregistered artists, producers, engineers, managers, record executives and songwriters this number would swell to well over 15 million musical artists in the U.S. alone with more musical artists worldwide. Global recorded music sales totaled $16.5 billion in 2012. There are three major record companies (Sony, Universal, Warner) that control 70% of the world music market and 80% of the United States market. There are over 500,000 independent record labels in the U.S. and abroad that divide the remaining 30% and 20% revenue figures respectively. As far as total value by country, the United States and Japan represent over 50% of the music industry sales revenue with the remaining revenue being split between the rest of the world.

The music world is incrementally adapting to the digital revolution by providing audiences with the experiences they want and successfully monetizing music through a range of business models. However, with all of this volume, revenue and even two centuries of experience, the music industry still remains relatively antiquated in its use of data to analyze talent, understand what makes artists successful and identify what makes audiences adore them. Record companies spend around 16% of their budgets on acquiring new talent and roughly $1 million per artist to break successful acts into major markets. As a consequence, the risk of misjudgment comes at an extremely high cost. It is a commonly stated fact that no other industry spends as much as the music industry (as a percentage of revenue) on research and development aka “A&R”. Even with this trend, record companies still don't have the type of analytics required to make the databased decisions that yield high ROI on talent recruitment. Recording artists are just one of the types of artists (including visual artists, athletes, and other performing artists) facing similar issues. Accordingly, there is a need for a quantitative metric score to assess talent and rate opportunities in the global music and creative industries. Use of this metric can be used to direct the resources of artistic promoters (e.g.: record label companies) to artists and performers based upon their score.

The present invention addresses these and other needs in the art.

### SUMMARY

The present invention provides a system for generating a score for an artist to compare the artist's successes and ranking against those of his/her/their peers. From this generated score, artists can be ranked (for example, by record labels or other creative promoters), such that resources can be directed to the best performers, or to performers that are rising in popularity in their artistic communities. In accordance with the preferred invention, the score for each of the artists can be transmitted through a computer network such that current and potential audience members can contribute to the rating and scoring of the artists. The qualitative comments and viewpoints of the audience members can be incorporated into the scores that the artists receive. Moreover, the scores themselves can be continuously updated based on continually incoming and updated data such that artists can be seen as rising or falling in popularity and artistic quality.

In one exemplary aspect, the present invention comprises a method of generating an artist's score, comprising:

(a) identifying a peer group for the artist;

(b) selecting at least one quantitative metric to be measured for the peer group and for the artist;

(c) measuring the at least one selected quantitative metric for the peer group;

(d) measuring the at least one selected quantitative metric for the artist;

(e) comparing the measured quantitative metric for the artist to the measured quantitative metric for the peer group, thereby generating a quantitative score for the artist;

(f) selecting at least one qualitative metric for the artist;

(g) semantically analyzing the at least one selected qualitative metric for the artist;

(h) ranking results of the semantic analysis of the selected qualitative metric on a predetermined scale, thereby generating a qualitative score for the artist; and

(i) selecting weightings for each of the quantitative score for the artist and the qualitative score for the artist; and

(j) combining the quantitative and qualitative scores into a final artist's score.

In various aspects, the qualitative and quantitative metrics can include a plurality of different qualitative or quantitative metrics taken together. This feature gives the present invention a powerful tool to analyze a number of different factors simultaneously when calculating the final artistic score for each artist or performer.

In optional aspects of the invention, the selected quantitative metric may comprise one or more of: (i) presence metrics, (ii) product metrics, (iii) popularity metrics, (iv) productivity metrics, or (iv) profitability metrics. Similarly, the selected qualitative metric may comprise one or more of: (i) presence metrics; (ii) product metrics; or (iii) popularity metrics.

In quantitative terms, qualitative presence metrics may comprise one or more of: (i) number of ticket sales; or (ii) cost per ticket. Qualitative product metrics may comprise one of more of: (i) number of plays, (ii) number of downloads, or (iii) number of purchases. Qualitative popularity metrics may comprise one or more of: (i) number of followers; (ii) number of likes, (iii) number of social media accounts; (iv) number of video views; (v) number of blogs; (vi) number of streams; (vii) number of retweets; (viii) number of mentions; (ix) number of web page views, (x) number of comments on a work or performance of the artist; or (xi) number of comments related directly to the artist. Lastly, qualitative productivity metrics may comprise one or more of: (i) number of performances; (ii) number of releases; or (iii) number of media numbers of the artist.

In qualitative terms, qualitative profitability metrics may comprise one or more of: (i) size of a target audience of the artist; (ii) revenue opportunity in the target audience; (iii) market share in the target audience; or (iv) projected expenditure for launching and managing the artist. Qualitative popularity metrics may comprise one or more of: (i) the artist's personality, (ii) the artist's appearance, (iii) the artist's benevolence, or (iv) the artist's authenticity. Lastly, qualitative product metrics may comprise one or more of: (i) the artist's writing, (ii) the artist's song choice, (iii) the artist's creativity, (iv) the artist's likeability, or (v) the artist's originality.

In addition to providing a score, the present invention further provides a method of directing resources to an artist based upon measured audience reception (i.e. score), comprising:

(a) generating the final artists score for a plurality of artists;

(b) ranking each of the artists on the basis of their final artist score; and

(c) directing resources to the artists with higher final artist score rankings.

The actual directing of resources to the artists with higher final artist score rankings may optionally comprise at least one of: (i) increasing the frequency of the artist's performances as compared to artists having lower final artist score rankings, (ii) increasing the number of individuals who are invited to attend or view or listen to the artist's performances, (iii) increasing the amount of funding spent on promoting the higher scoring artists, (iv) changing the venues at which the higher scoring artist performs, (v) changing the advertisements associated with promotion of the higher scoring artist, or (vi) increasing media discussion associated with promotion of the higher scoring artist.

In further aspects of the present invention, a networked dedicated computer system is provided to perform the preferred method. As such, the present invention provides a computer system for directing resources to artists based upon a generated artist's score, comprising:

(a) a plurality of audience member computer systems each configured to receive input from one of the audience members, and to transmit the inputted data over a network;

(b) a plurality of artistic promoter computer systems configured to receive data over the network; and

(c) a score generating computer system configured to generate artist scores for a plurality of artists, and to transmit the artist scores over the network to the plurality of artistic promoter computer systems, thereby enabling the artistic promoter computer systems to direct resources to selected artists on the basis of the scores generated for each of the artists, wherein the score generating computer system configured to generate artist scores comprises:
(i) a score processor,
(ii) a quantitative assessment module configured to:
   (a) receive data sets over the network, the data sets representing quantitative data metrics for a plurality of artists,
   (b) select a peer group for each artist;
   (c) compare the data sets representing quantitative data metrics for a selected artist to the data sets representing quantitative data metrics for the other artists in the peer group, to thereby generate a quantitative score for the artist, and then communicate the quantitative score for the artist to the score processor,
(iii) a qualitative assessment module configured to receive data over the network that the audience members have inputted into the audience member computer systems, and to communicate the received data to a semantic analysis module,
(iv) the semantic analysis module configured to semantically analyze and rank the data received from the qualitative assessment module to generate a qualitative score for the artist, and then communicate the qualitative score for the artist to the score processor,

wherein the score processor is configured to select weightings for each of the quantitative score for the artist and the qualitative score for the artist, and then combine the weighted qualitative and quantitative scores into a final artist score for each artist, and
(v) a score transmission module in communication with the score processor, the score transmission module configured to transmit the final artist score for each artist over the network to the artist, and to transmit the final artist scores for the plurality of artists to each of the plurality of artistic promoter computer systems, and

wherein the plurality of artistic promoter computer systems are each configured to direct resources to the plurality of artists in relation to the final artist scores for each artist.

The present invention has numerous advantages, including, but not limited to the following. First, it provides a centralized and standardized system to rate artists and performers who are scattered in different geographical regions, and across different artistic communities. Second, the score the artists each receive is useful information to a number of different parties. For example, music promoters (e.g.: record label companies) want to know this score as a way to finding talent to support as quickly as possible, and with minimal time and cost wasted searching for this talent. This helps the music promoters focus their resources on those most successful artists and performers. Third, by identifying successful and up and coming artists and performers quickly, the potential audience is able to be quickly directed to select their music or art quickly in an environment of so many possible choices that audience members are typically overwhelmed by potential artists. Fourth, the artists themselves are keen consumers of their own artistic scores as these score help them both gauge their success and determine which of their actions have most contributed to their own success. In this way, the artists are able to focus on the events or artistic compositions that have been most successful. For example, a musician can quickly determine which styles they have used meet with best audience reception, and use this style more in their compositions.

These and other features, aspects, and advantages of the present invention will become apparent to those skilled in the art after considering the following detailed description, appended claims and accompanying drawings.

### BRIEF DESCRIPTION OF THE DRAWINGS

FIG. 1 illustrates a computer system of generating individual scores for a plurality of different artists, incorporating feedback from audience members, and transmitting the scores throughout a network or artists, audience members and artistic creative promoters.

FIG. 2 depicts an exemplary flow chart of data, analyses, generations, evaluations, and comparisons according to a frequently preferred embodiment of the present system in which the artist's score is generated by combining both quantitative and qualitative data.

FIG. 3 depicts one embodiment of a perception report or report card, including an explanation of each category within an exemplary artist's score.

FIG. 4 depicts exemplary performance data regarding the top public feedback countries and cities optionally supplied with an artist's score.

FIG. 5 depicts exemplary product data regarding song popularity (A) and music play frequency (B) optionally supplied with an artist's score.

FIG. 6 depicts exemplary popularity data such as social media demographics, fan number, popularity trajectory, and target audience optionally supplied with an artist's score.

### DETAILED DESCRIPTION

For clarity of disclosure, and not by way of limitation, the detailed description of the invention is divided into the subsections that follow.

Unless defined otherwise, all terms of art, notations and other scientific terms or terminology used herein have the same meaning as is commonly understood by one of ordinary skill in the art to which this disclosure belongs. In some cases, terms with commonly understood meanings are defined herein for clarity and/or for ready reference, and the inclusion of such definitions herein should not necessarily be construed to represent a substantial difference over what is generally understood in the art. All patents, applications, published applications and other publications referred to herein are hereby incorporated by reference for at least the reasons for which they are cited. If a definition set forth in this application is contrary to or otherwise inconsistent with a definition set forth in the patents, applications, published applications and other publications that are herein incorporated by reference, the definition set forth in this application prevails over the definition that may be incorporated by reference.

As used herein, the term “a” or “an” means “at least one” or “one or more.”

As used herein, the term “artist” is meant in its broadest sense including artists in music and other visual and performing arts.

For music industry participants who have no efficient way of measuring, comparing or analyzing talent, the present artistic score generating system produces a score that functions as a social perception measurement that provides real-time (i.e.: continuously updated or periodically updated), accurate and predictive insights into how that artist can identify and grow their audience or the audience of another artist, entity, or the like. Unlike record companies or music intelligence firms, the currently disclosed system preferably provides a score as a single, simple unit of measurement to determine an individual or group's reputation.

The inventors have identified a variety of trends in the music industry that may be important for an artist to keep in mind as they develop their reputation. In particular, these trends include the following:
a. Artist/Group Development: Particular to the music industry, record companies are becoming less involved in artist and group development compared with the past. Expectations have changed such that these companies desire artists who already have an established brand, reputation, following, and respective talent to be polished and ready to launch as a major or sponsored artist as soon as possible. These trends are not so limited to the music industry, however, as other creative individuals such as painters, actors, comedians, gamers or the like are also expected by the relevant agencies/companies to have an established brand, reputation, following, etc.
b. Social Media: Companies are migrating from traditional talent recruiting methods that involved physically traveling to showcases and talent shows to viewing prospective artists or groups through social media outlets such as MySpace, YouTube, Face book, Twitter, Instagram, BitTorrent, Tumblr, Pinterest, Soundcloud, Reverbnation, Spotify, Pandora, Groovesark, LastFM and any to-be-developed platform for social media or content sharing.
c. Digital Transformation: There is a growing trend/concern to some that the digital age, social media, streaming and piracy will eliminate the need for production, distribution, promotion and marketing of new talents in the creative arts such as music. Digital sales, however, are up 14% year over year.
d. DIY: Self-promotion and self-publishing by the artist or group is much easier to pursue today than it used to be with outlets such as self-publishing blogs, mobile apps, ad websites or other publically available platforms such as iTunes and Amazon. Increasing numbers of artists are considering the independent distribution route as they see signing to a major label as next to impossible.
e. Free music: Providing of music for free is a growing desire amongst fans and artists who see music merely as an expression of art. There are a number of Bit Torrent sites that allow people to upload and share music for free.

The present “final artist score” (also referred to as an INSYTE SCORE™) comprises a measurement that reflects the quantified perception that the public has about an artist, group or the like. Increasing the score means, for example, that the volume and quality of an artist's, groups content (e.g.: music) (or other trade) as well as the public perception of the artist or group has improved. This improvement directly translates to greater audience engagement, increased referrals, more product and merchandise purchases, a greater number of fans and positive public perception. The present artist thereby provides a holistic picture to an artist or group and their management team. The artist score preferably includes a measure of a variety of metrics, including audience/public sentiment in its scoring model, as will be shown. In certain embodiments, audience feedback and purchase/attendance records also contribute to the generation of the overall final artist score.

In certain frequent embodiments, the final artist score is composed of multiple metrics including Performance, Product and Popularity. Understanding these metrics can help the artist or group adjust certain behaviors that lead to career success based on measured trends of the final artist score.

Performance reflects, for example, data surrounding audience attendance at live events. This includes ticket sale information and commentary around key elements that most influence how audiences perceive how good or bad their experience was at these performances. Product reflects, for example, data surrounding the actual artist's recordings. This includes purchases, plays, downloads, streams and commentary around key elements that most influence how audiences perceive how good or bad the recordings to be. Popularity reflects, for example, data surrounding the reputation of the artist. This includes social media data such as “likes,” followers, “tweets” (e.g., provided on a social media such as Twitter) and views and commentary around key elements that most influence how audiences perceive the “likeability” of the artist.

There are a variety of measures that may optionally be packaged in to an artist score, for example, Target Audience Profile (TAP), Presence, Product, Popularity, Productivity and Profitability. These measures are described in further detail below. In an exemplary embodiment, a Score ranges from 1-100, including the following break-down:

a) 1-20 (Very Poor)

b) 21-40 (Bad)

c) 41-60 (Okay)

d) 61-80 (Good)

e) 81-100 (Excellent)

Optionally, the artist score result may be categorized with a term such as excellent, good, okay, bad, poor, very poor, etc. based on the numerical output of the analyses described herein. The artist score takes into account, for example, a variety of types of data, including and a percentage/weight of categorical score as further explained below. For example, Quantitative Data (e.g., “How much?”) may be weighted at, for example, 60% and is often evaluated via a numerical analysis. Qualitative Data (e.g., “How good?”) may be weighted at, for example, 40% and is often evaluated via a word choice and usage analysis.

Target Audience Profile (TAP)—is a metric that comprises people who are most likely to support the artist.

In preferred embodiments, the quantitative portion of the score can be composed of: Presence metrics, Product metrics, Popularity metrics, Productivity metrics and Profitability metrics, as will be explained below. These five metrics can also be combined in a weighted manner to make up a combined quantitative portion of the final artist score, as will also be explained below.

From the artist's perspective, Presence is a metric that considers the question—“how are my events?” This, for example, may be weighted at 15% of the qualitative portion of the final artist score (often between 1%-40%) and often measures the amount of entertainment value that an audience receives for the event in connection with, for example, live events and/or concerts of an artist. Presence evaluation often takes into account quantitative data such as ticket Sales (units/dollars) and cost per ticket type. Presence evaluation also often takes into account a variety of qualitative data. Some of the categories of qualitative data include one or more of venue, length, line-up/sequence, choreography, engagement, talent, price, seating, concert, lighting, and/or appearance.

From the artist's perspective, Product is a metric that considers the question—“how is my music?” or “how is my product?” This, for example, may be weighted at 35% of the quantitative portion of the final artist score (often between 15%-60%) and often measures the appeal of the actual artist or recording. Product evaluation often takes into account quantitative data such as plays, downloads, and/or purchases. Presence evaluation also often takes into account a variety of qualitative data. Some of the categories of qualitative data include one or more of writing, song choice, creativity, likeability, and/or originality.

From the artist's perspective, Popularity is a metric that considers the question—“how is my reputation?” This, for example, may be weighted at 30% of the quantitative portion of the final artist score (often between 10%-50%) and often measures the proportion of people in the target audience profile who have communicated about their experience with the artist. Product evaluation often takes into account quantitative data such as one or more of the following: followers, “likes,” social media accounts, video views, blogs, streams, “retweets,” mentions, web page views, and/or comments. Presence evaluation also often takes into account a variety of qualitative data. Some of the categories of qualitative data include one or more of personality, appearance, benevolence, and/or authenticity.

From the artist's perspective, Productivity is a metric that considers the question—“am I working hard enough?” This, for example, may be weighted at 15% of the quantitative portion of the final artist score (often between 1%-40%) and often measures the activity of the artist in terms of recording, performing and social media activity to correlate the activities and their subsequent responses from the audience. In certain embodiments, Productivity includes how an artist's audience reacts to new activity. Productivity evaluation often takes into account one or more of the following: performances (e.g., fans/sales revenue), releases (e.g., fans views, plays, downloads, etc.), and/or media (e.g., sm/general media/interviews/blogs, fans/views/plays/downloads/clout).

From the artist's perspective, Profitability is a metric that considers the question—“how much am I worth?” This, for example, may be weighted at 5% of the of the quantitative portion of the final artist score (often between 0%-30%) and often measures long-term profitability of an artist by considering, for example, the size of their target audience, the revenue opportunity and competition in that segment, as well as the projected expenditures involved in launching and managing the artist.

The score, in certain embodiments, can account for a variety of additional measures including, for example, Engaged Audience Rating (EAR) (e.g., what percentage of your audience is engaged?) and Trending.

Technology. Obtaining Score information often involves the use of electronic systems such as an artist interface and access to an online network. In certain embodiments, a web based dashboard is provided for presentation of data and analyses to an artist. Also, an application programming interface (API) is often used to pull information from remote data sources, servers, or local or remote databases. Also, often email or social media is utilized to convey a Score or Score information to or from an artist.

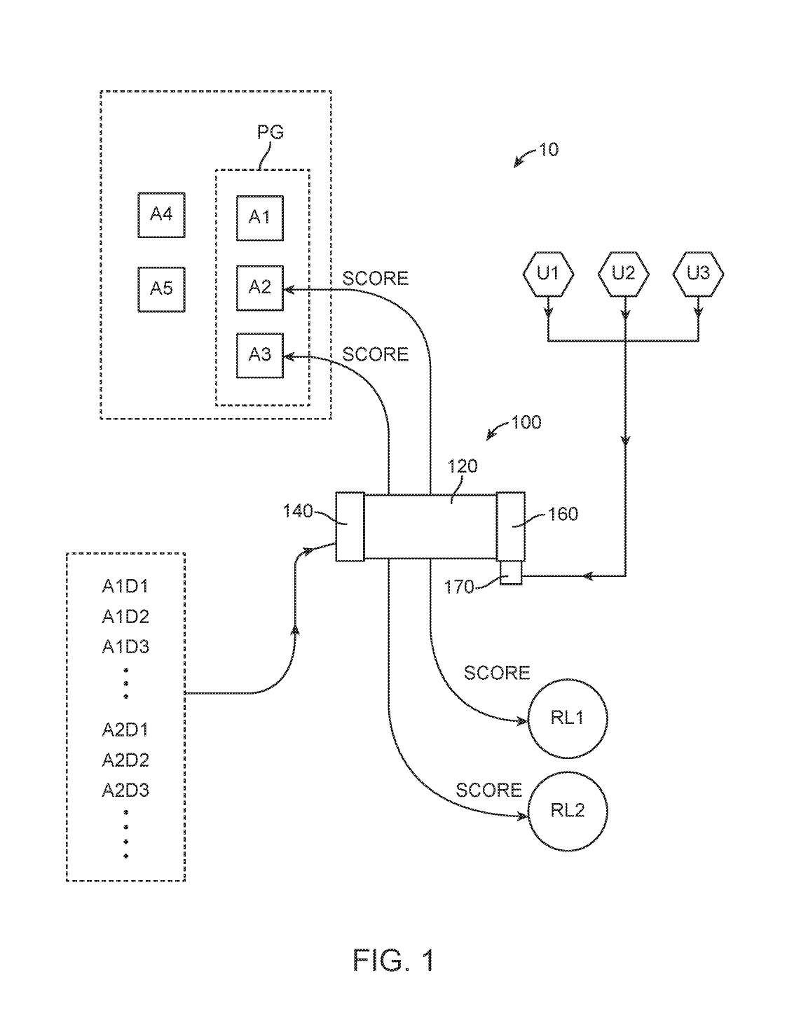

For example, referring first to FIG. 1, a computer system for generating individual scores for a plurality of different artists, and transmitting the scores throughout a network or artists, audience members and artistic creative promoters is provided.

Computer system 10 can be used both to generate scores and for artistic promoters to direct resources to certain high scoring (or upwardly trending scoring) artists. Computer system 10 preferably comprises a plurality of audience member (e.g.: users) computer systems U1, U2, U3 that are each configured to receive input from one of the audience members, and to transmit the inputted data over a network. Preferably, each audience member computer system U1, U2, etc. is simply a smartphone running a smartphone app that allows the users to input data ranking, rating, writing review or commenting on, or otherwise providing feedback on a plurality of artists A1, A2, A3 . . . etc. that they have an opinion on. For example, if user U1 enjoys a concert by artist A1, user U1 may then rate their enjoying the concert and write a review in the app on their smartphone. Similarly, if user U2 does not enjoy a convert from artist A2, then user U2 may rate their negative experience in the app on their own smartphone. As will be explained, the data entered by users U1, U2, U3 into their smartphones (or other digital devices) can be transmitted over a network to a score generating computer system 100.

Computer system 10 also includes a plurality of artist creative promoter computer systems (e.g.: record label company computer systems RL1, RL2) configured to receive data over the network.

Score generating computer system 100 is configured to generate artist scores for a plurality of artists, and to transmit the artist scores over the network to the plurality of artist promoter computer systems (e.g.: record label companies RL1 and RL2), thereby enabling the artist promoter computer systems to direct resources to selected artists on the basis of the scores generated for each of the artists.

Score generating computer system 100 preferably comprises a score processor 120, a quantitative assessment module 140, a qualitative assessment module 160 and a score data transmission system 180.

Score generating system 100 is configured to: (a) receive data sets over the network, the data sets representing quantitative data metrics for a plurality of artists, (b) select a peer group for each artist; and (c) compare the data sets representing quantitative data metrics for a selected artist to the data sets representing quantitative data metrics for the other artists in the peer group, to thereby generate a quantitative score for the artist, and then communicate the quantitative score to the artist.

For example, score generating system 100 may have information on five artists A1, A2, A3, A4 and A5. (Note: This example is highly simplified as the present system will typically simultaneously track hundreds or thousands of artists). Continuing with the illustrated example, score generating 100 may quickly determine that although artists A1, A2, A3, A4 and A5 are all musicians, only artists A1, A2 and A3 are folk musicians. Therefore, when generating a score for these folk musicians, the present system will only compare musicians A1, A2 and A3 against one another. Thus, the group of musicians A1, A2 and A3 are a determined “peer group” PG, as illustrated.

Exemplary data sets received into quantitative assessment module 140 are illustrated as A1D1, A1D2, A1D3 . . . etc. and A2D1, A2D2, A2D3, etc. Examples of what such data sets may include can optionally be as follows. “A1D1” can be the total ticket sales of artist A1. “A2D1” can be the total ticket sales of artist A2. Similarly, “A1D2” can be the ticket sale price for artist A1, and “A2D2” can be ticket sale price for artist A2. (Thus, the artist is represented as An, and the quantitative metric to be measured and analyzed is represented as Dn). It is to be understood, however, that this form of data set is merely exemplary and that any form of dataset may be used, all keeping within the scope of the present invention. Datasets A1D1 . . . etc. may be transmitted to system score generating 100 by any suitable means including web browsing followed by operator input, pre-established data communications channels between parties in the artistic community, email, etc. In the case of ticket sales information, this information can be obtained directly from the organizer of the sales for the venue. Alternatively, the datasets representing qualitative information and metrics for each of the artists A1, A2, A3, etc. can even be obtain in whole or in part from the artists themselves. It is to be understood that the present invention is not limited to any particular form or transmission data for the data sets representing quantitative assessments or metrics of the artists.

Qualitative assessment module 160 is configured to receive data over the network that the audience members have inputted into the audience member computer systems U1, U2 and U3, and to communicate the received data to semantic analysis module 170. For example, users U1, U2 . . . etc. may write reviews or commentary on the artists A1, A2, A3 . . . etc. based upon their experiences listening to music from these artists, watching their videos or attending their performances.

Semantic analysis module 170 is configured to semantically analyze and rank the data received from qualitative assessment module 160 to generate a qualitative score for the artist, and then communicate the qualitative score for the artist to the score processor 120. For example, semantic analysis module 170 may be programmed to flag and count certain words or phrases in the reviews written by users U1, U2 . . . etc. If semantic analysis module repeatedly recognizes words like “great”, “excellent”, or “amazing”, then it would return a more favorable (higher scoring) result to score processor 120. Conversely, if semantic analysis module repeatedly recognizes words like “terrible”, “boring”, or “pathetic”, then it would return a more negative (lower scoring) result to score processor 120. The advantage of including semantic analysis module 170 in the present system is that it provides a quantifiable and reproducible way to include qualitative assessments of the artists into a formal numerical scoring system. Previous approaches to making a qualitative assessment of an artist or performer tended to be centered around a person reading a series of reviews and then forming their own impression of the artist. However, with the present semantic analysis module 170, a (very) large number of written reviews can be simultaneously reviewed and analyzed by a computer scoring system.

In various optional aspects, semantic analysis module 170 evaluates comments posted in a social media outlet for key words or phrases. Such social media outlets and postings can comprise data published by ay one or more of Twitter, Instagram, Facebook, Soudcloud, Reverbnation, Spotify, Pandora, Grooveshark, or LastFM. Optionally as well, the key words or phrases can be ranked on a pre-determined multi-part scale. In various aspects, the predetermined scale may comprise a three-part scale composed of a positive ranking, a neutral ranking, and a negative ranking. It is to be understood, however, that the present invention is not so limited, and may encompass other systems.

Score processor 120 is configured to first select weightings for each of the quantitative score for the artist and the qualitative score for the artist, and then combine the weighted qualitative and quantitative scores into a final artist score for each artist.

Score transmission module 180 is in communication with score processor 120. Score transmission module 180 is configured both to transmit the final score for each artist over the network both to the artists A1, A2, A3, etc., and to each of the plurality of artistic creative promoter computer systems RL1, RL2. In this way, the artists receive their own scores, and can vary or improve their performance and audience reception over time. This score is thus very helpful to artists in terms of their own creative development. In addition, the artistic creative promoters RL1, RL2 also receive the scores for each of the various artists.

Preferably, each of the plurality of artist promoter computer systems RL1, RL2 are configured to direct resources to the plurality of artists in relation to the final artist scores for each artist. One advantage of the present system is that the scores given to the artistic creative promoters can be used to direct resources to the higher scoring artists and performers.

For example, in various aspects, the plurality of artist promoter computer systems RL1, RL2 are each configured to post commentary to websites to accessible to the audience member computer systems over the network to: (i) increase the frequency of the artist's performances as compared to artists having lower final score rankings, (ii) increase media discussion associated with promotion of the artist as compared to artists having lower final score rankings, or (iii) increase the number of audience members who are invited to attend or view or listen to the artist's performances.

In further optional aspects, the artistic creative promotors RL1, RL2 use the scoring information to communicate with advertisers (or advertising services) to change the advertisements associated with the promotion of the artist. Moreover, the artistic creative promotors RL1, RL2 may use the scoring information to contact concert organizers and change the venues at which the various artists perform. It is to be understood that the above examples are merely exemplary, and that the present invention encompasses any system that facilitates an artistic creative promoter to direct any form of recourses (time, money, webspace, advertisements, etc.) to any artist or performer based upon their artist scores generated in accordance with the present invention.

Preferably, the data received by quantitative assessment module 140 comprises one or more of: (i) presence metrics, (ii) product metrics, (iii) popularity metrics, (iv) productivity metrics, or (iv) profitability metrics, as illustrated further herein.

Preferably as well, the data received by the qualitative assessment module 160 comprises one or more of: (i) presence metrics; (ii) product metrics; or (iii) popularity metrics, as illustrated further herein.

In other preferred aspects, the present invention comprises a method of generating an artist's score, comprising: (a) identifying a peer group for the artist; (b) selecting at least one quantitative metric to be measured for the peer group and for the artist; (c) measuring the at least one selected quantitative metric for the peer group; (d) measuring the at least one selected quantitative metric for the artist; (e) comparing the measured quantitative metric for the artist to the measured quantitative metric for the peer group, thereby generating a quantitative score for the artist; (f) selecting at least one qualitative metric for the artist; (g) semantically analyzing the at least one selected qualitative metric for the artist; (h) ranking results of the semantic analysis of the selected qualitative metric on a predetermined scale, thereby generating a qualitative score for the artist; and (i) selecting weightings for each of the quantitative score for the artist and the qualitative score for the artist; and (j) combining the quantitative and qualitative scores into a final artist's score.

Preferably, selecting at least one quantitative metric comprises selecting a plurality of different quantitative metrics to measure. Similarly, selecting at least one qualitative metric comprises selecting a plurality of different qualitative metrics to measure.

In optional aspects of the scoring system, the qualitative score may be weighted as 40% to 80% of the final artist's score and the qualitative score may be weighted as 20% to 60% of the final artist's score. In one preferred aspect, the qualitative score may be weighted as 60% of the final artist's score and the qualitative score may be weighted as 40% of the final artist's score.

Optionally, the selected quantitative metric comprises one or more of: (i) presence metrics, (ii) product metrics, (iii) popularity metrics, (iv) productivity metrics, or (iv) profitability metrics.

In one aspect, the presence metrics may be weighted as 15% of the score, the product metrics may be weighted as 35% of the score, the popularity metrics may be weighted as 30% of the score, the productivity metrics may be weighted as 30% of the score, the productivity metrics may be weighted as 15% of the score and the profitability metrics may be weighted as 5% of the score.

Preferably, the selected qualitative metric comprises one or more of: (i) presence metrics; (ii) product metrics; or (iii) popularity metrics.

In various optional aspects, the quantitative presence metrics comprises one or more of: (i) number of ticket sales; or (ii) cost per ticket.

In various optional aspects, the quantitative product metrics comprises one of more of: (i) number of plays, (ii) number of downloads, or (iii) number of purchases.

In various optional aspects, the quantitative popularity metrics comprises one or more of: (i) number of followers; (ii) number of likes, (iii) number of social media accounts; (iv) number of video views; (v) number of blogs; (vi) number of streams; (vii) number of retweets; (viii) number of mentions; (ix) number of web page views, (x) number of comments on a work or performance of the artist; or (xi) number of comments related directly to the artist.

In various optional aspects, the quantitative productivity metrics comprises one or more of: (i) number of performance; (ii) number of releases; or (iii) number of media numbers of the artist.

In various optional aspects, the quantitative profitability metrics comprises one or more of: (i) size of a target audience of the artist; (ii) revenue opportunity in the target audience; (iii) market share in the target audience; or (iv) projected expenditure for launching and managing the artist.

In various optional aspects, the qualitative popularity metrics comprise one or more of: (i) the artist's personality, (ii) the artist's appearance, (iii) the artist's benevolence, or (iv) the artist's authenticity.

In various optional aspects, the qualitative product metrics may comprise one or more of: (i) the artist's writing, (ii) the artist's song choice, (iii) the artist's creativity, (iv) the artist's likeability, or (v) the artist's originality.

In accordance with the present system, the measured quantitative metric for the artist, the measured quantitative metric for the peer group, and the at least one qualitative metric for the artist are continuously updated at regular intervals of time. Stated another way, the present system inputs continually updated datasets A1D1 . . . etc. representing quantitative metrics and continuously updated qualitative commentary from users U1, U2 . . . etc.

In other preferred aspects, the present invention comprises a method of directing resources to an artist based upon measured audience reception, comprising: (a) generating the final artists score for a plurality of artists using the above described method; (b) ranking the artists on the basis of their final artist score; and (c) directing resources to the artists with higher final artist score rankings.

Optionally, the method of directing resources to the artists with higher final artist score rankings comprises at least one of: (i) increasing the frequency of the artist's performances as compared to artists having lower final score rankings, (ii) increasing the number of individuals who are invited to attend or view or listen to the artist's performances, (iii) increasing the amount of funding spent on promoting the higher scoring artists, (iv) changing the venues at which the artist performs, (v) changing the advertisements associated with promotion of the artist, or (vi) increasing media discussion associated with promotion of the artist.

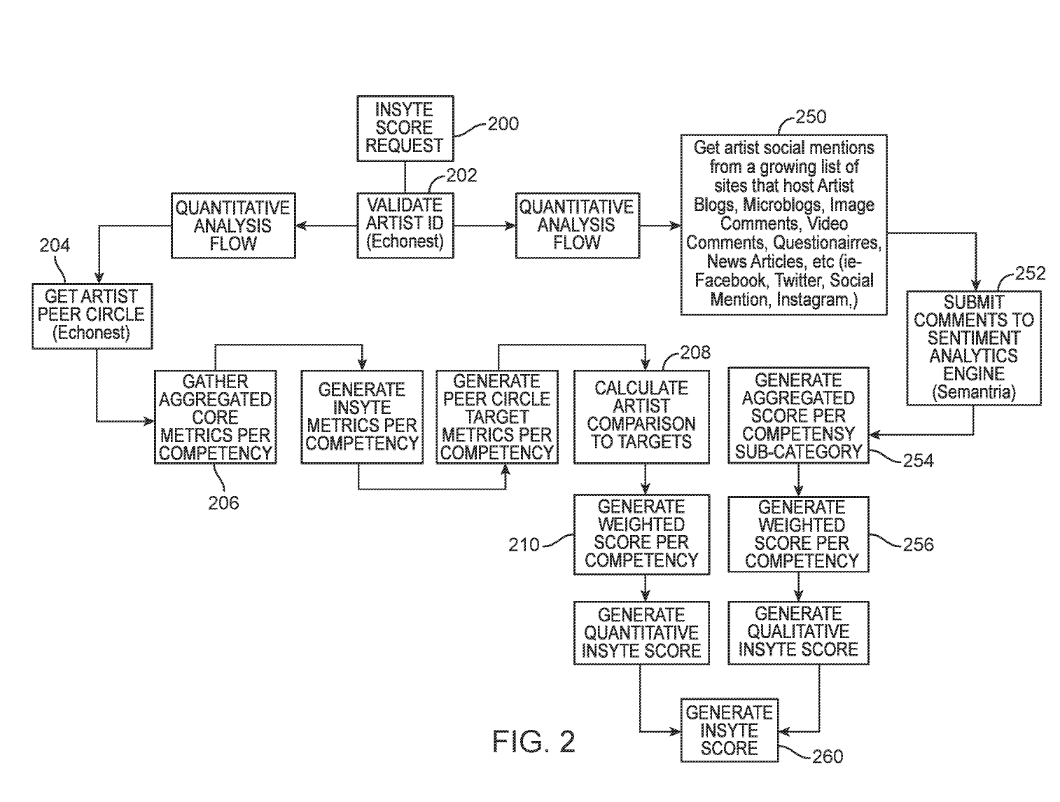

FIG. 2 depicts an exemplary flow chart of data, analyses, generations, evaluations, and comparisons according to a frequently preferred embodiment of the present system in which the artist's score is generated by combining both quantitative and qualitative data. Specifically, a score request 200 is sent from an artist (A1 in FIG. 1) to the score generating system (100 in FIG. 1). First, the artist is validated at step 202. Next, the components of the qualitative and quantitative scores are separately determined. The quantitative analysis begins with defining the artist's peer group (PG in FIG. 1) at step 204. At step 206, qualitative metrics (datasets A1D1 . . . etc. in FIG. 1) are analyzed and at the metrics of the particular artist are compared to the targets at step 208. A weighted qualitative score is calculated at step 210 (by score processor 120 in FIG. 1). The flow of qualitative analysis proceeds concurrently, as follows. At step 250, the comments and impressions of various audience members (users U1, U2 . . . etc. in FIG. 1) are gathered. These can include social media mentions or postings from the users Un or viewed by the users Un, including but not limited to, artist blogs, microblogs, image commentary, video commentary, news articles, comments taken from Facebook or Twitter, Instagram, etc.). At step 252, these qualitative metrics can be sent to a semantic analysis system (170 in FIG. 1). Next, at step 254, the artist's aggregated qualitative score is generated. At step 256, a weighted qualitative score is calculated (by score processor 120 in FIG. 1). Finally, at step 260, the weighted qualitative and quantitative scores are combined into the artist's final score (by score processor 120 in FIG. 1). This final score is the score that is sent both to the various artists An and to the various creative promoters RLn.

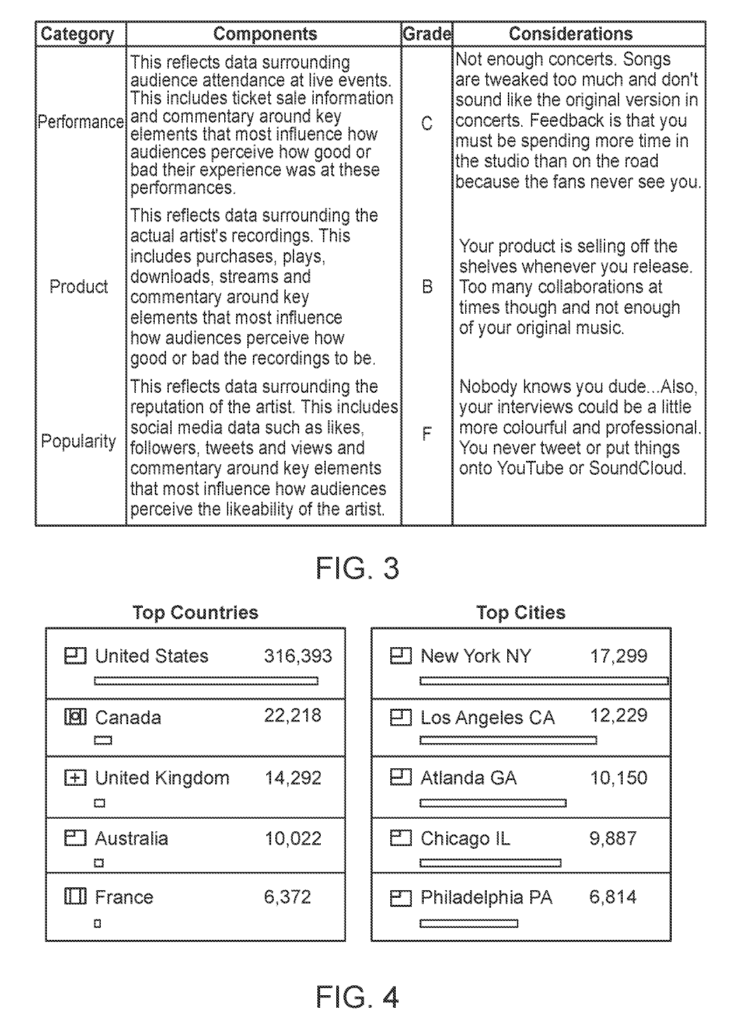

FIG. 3 depicts one embodiment of a perception report or report card, including an explanation of each category within an exemplary artist's score. In this particular example, the artist's performance, product and popularity are separated out of the final score and graded with letter grades, and considerations for the artist to think about are presented corresponding to these letter grades. It is to be understood that the present invention encompasses both generating a simple numerical score for the artist's final score, and also to embodiments in which the numerical score is supplemented with additional data, including but not limited to that described in FIGS. 4, 5 and 6 below.

FIG. 4 depicts exemplary performance data regarding the top public feedback countries and cities optionally supplied with an artist's score. This data gives the artist An and artistic promoter Pln information as to what countries and cities the artist's performances are playing in.

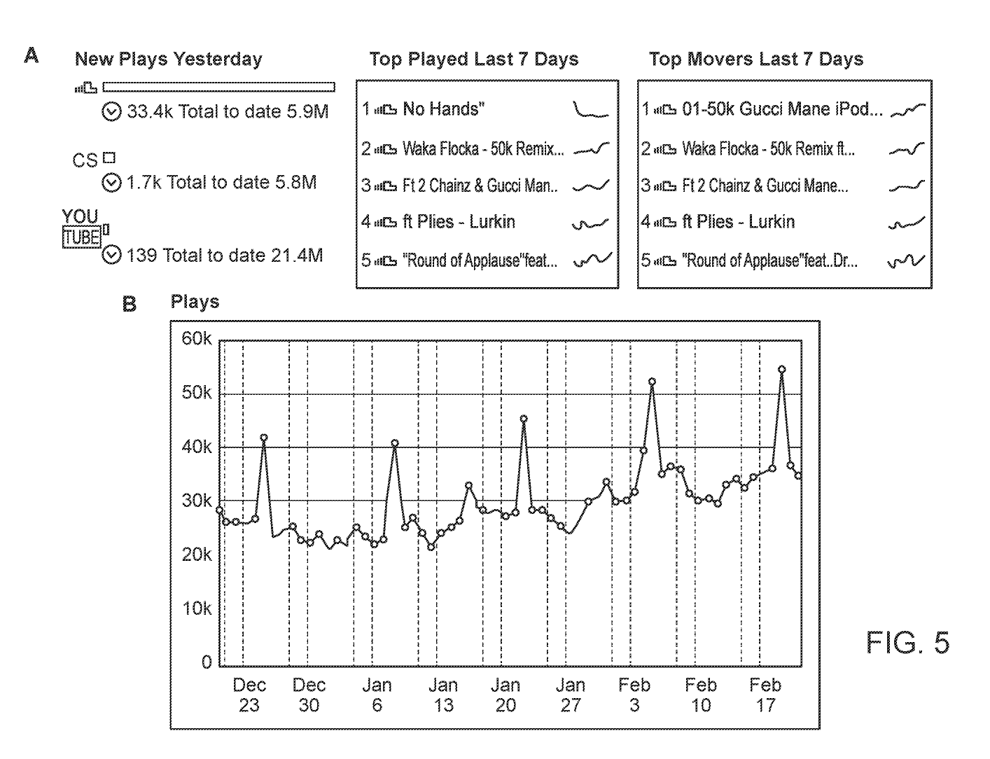

FIG. 5 depicts exemplary product data regarding song popularity (A) and music play frequency (B) optionally supplied with an artist's score. This data gives the artist An and artistic promoter Pln information as to what new songs are playing, what songs are most played and what songs are the fastest chart movers.

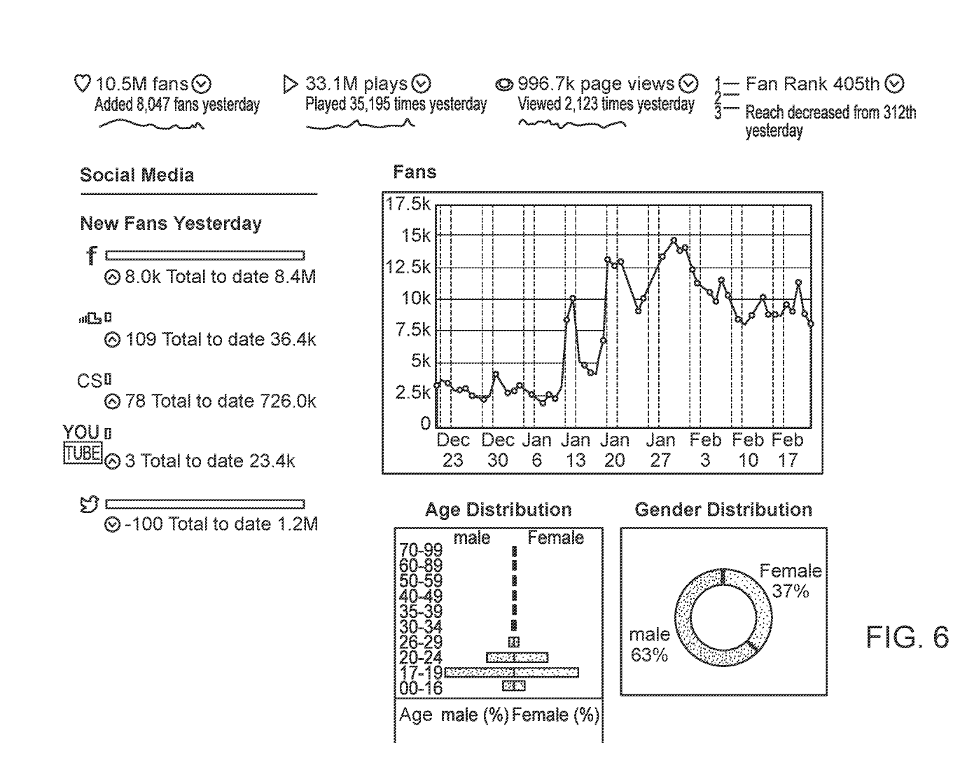

FIG. 6 depicts exemplary popularity data such as social media demographics, fan number, popularity trajectory, and target audience optionally supplied with an artist's score. This data gives the artist An and artistic promoter Pln graphical information as to the number of fans, and how the number has changed over time, as well as the age and gender distribution of the artist's audience.

Numerous modifications may be made to the foregoing systems without departing from the basic teachings thereof. Although the present invention has been described in substantial detail with reference to one or more specific embodiments, those of skill in the art will recognize that changes may be made to the embodiments specifically disclosed in this application, yet these modifications and improvements are within the scope and spirit of the invention, as set forth in the claims which follow.

The following is claimed:

1. A method of generating an artist's score, comprising:
(a) identifying a peer group for the artist;
(b) selecting at least one quantitative metric to be measured for the peer group and for the artist;
(c) measuring the at least one selected quantitative metric for the peer group;
(d) measuring the at least one selected quantitative metric for the artist;
(e) comparing the measured quantitative metric for the artist to the measured quantitative metric for the peer group, thereby generating a quantitative score for the artist;
(f) selecting at least one qualitative metric for the artist;
(g) semantically analyzing the at least one selected qualitative metric for the artist;
(h) ranking results of the semantic analysis of the selected qualitative metric on a predetermined scale, thereby generating a qualitative score for the artist; and
(i) selecting weightings for each of the quantitative score for the artist and the qualitative score for the artist; and
(j) combining the quantitative and qualitative scores into a final artist's score.

2. The method of claim 1, wherein selecting at least one quantitative metric comprises selecting a plurality of different quantitative metrics to measure.

3. The method of claim 1, wherein selecting at least one qualitative metric comprises selecting a plurality of different qualitative metrics to measure.

4. The method of claim 1, wherein the qualitative score is weighted as 40% to 80% of the final artist's score and the qualitative score is weighted as 20% to 60% of the final artist's score.

5. The method of claim 4, wherein the qualitative score is weighted as 60% of the final artist's score and the qualitative score is weighted as 40% of the final artist's score.

6. The method of claim 1, wherein the selected quantitative metric comprises one or more of: (i) presence metrics, (ii) product metrics, (iii) popularity metrics, (iv) productivity metrics, or (iv) profitability metrics.

7. The method of claim 6, wherein the presence metrics is weighted as 15% of the score, the product metrics is weighted as 35% of the score, the popularity metrics is weighted as 30% of the score, the productivity metrics is weighted as 30% of the score, the productivity metrics is weighted as 15% of the score and the profitability metrics is weighted as 5% of the score.

8. The method of claim 1, wherein the selected qualitative metric comprises one or more of: (i) presence metrics; (ii) product metrics; or (iii) popularity metrics.

9. The method of claim 6, wherein presence metrics comprises one or more of: (i) number of ticket sales; or (ii) cost per ticket.

10. The method of claim 6, wherein product metrics comprises one of more of: (i) number of plays, (ii) number of downloads, or (iii) number of purchases.

11. The method of claim 6, wherein popularity metrics comprises one or more of: (i) number of followers; (ii) number of likes, (iii) number of social media accounts; (iv) number of video views; (v) number of blogs; (vi) number of streams; (vii) number of retweets; (viii) number of mentions; (ix) number of web page views, (x) number of comments on a work or performance of the artist; or (xi) number of comments related directly to the artist.

12. The method of claim 6, wherein productivity metrics comprises one or more of: (i) number of performance; (ii) number of releases; or (iii) number of media numbers of the artist.

13. The method of claim 6, wherein profitability metrics comprises one or more of: (i) size of a target audience of the artist; (ii) revenue opportunity in the target audience; (iii) market share in the target audience; or (iv) projected expenditure for launching and managing the artist.

14. The method of claim 8, wherein the popularity metrics comprise one or more of: (i) the artist's personality, (ii) the artist's appearance, (iii) the artist's benevolence, or (iv) the artist's authenticity.

15. The method of claim 8, wherein the product metrics comprise one or more of: (i) the artist's writing, (ii) the artist's song choice, (iii) the artist's creativity, (iv) the artist's likeability, or (v) the artist's originality.

16. The method of claim 1, wherein the measured quantitative metric for the artist, the measured quantitative metric for the peer group, and the at least one qualitative metric for the artist are continuously updated at regular intervals of time.

17. A method of directing resources to an artist based upon measured audience reception, comprising:
(a) generating the final artists score for a plurality of artists using the method of claim 1;
(b) ranking the artists on the basis of their final artist score; and
(c) directing resources to the artists with higher final artist score rankings.

18. The method of claim 17, wherein directing resources to the artists with higher final artist score rankings comprises at least one of: (i) increasing the frequency of the artist's performances as compared to artists having lower final score rankings, (ii) increasing the number of individuals who are invited to attend or view or listen to the artist's performances, (iii) increasing the amount of funding spent on promoting the higher scoring artists, (iv) changing the venues at which the artist performs, (v) changing the advertisements associated with promotion of the artist, or (vi) increasing media discussion associated with promotion of the artist.

19. A computer system for directing resources to artists based upon a generated artist's score, comprising:
(a) a plurality of audience member computer systems each configured to receive input from one of the audience members, and to transmit the inputted data over a network;
(b) a plurality of artist promoter computer systems configured to receive data over the network; and
(c) a score generating computer system configured to generate artist scores for a plurality of artists, and to transmit the artist scores over the network to the plurality of artist promoter computer systems, thereby enabling the artist promoter computer systems to direct resources to selected artists on the basis of the scores generated for each of the artists, wherein the score generating computer system configured to generate artist scores comprises:
(i) a score processor,
(ii) a quantitative assessment module configured to:
(a) receive data sets over the network, the data sets representing quantitative data metrics for a plurality of artists,
(b) select a peer group for each artist;
(c) compare the data sets representing quantitative data metrics for a selected artist to the data sets representing quantitative data metrics for the other artists in the peer group, to thereby generate a quantitative score for the artist, and then communicate the quantitative score for the artist to the score processor,
(iii) a qualitative assessment module configured to receive data over the network that the audience members have inputted into the audience member computer systems, and to communicate the received data to a semantic analysis module,
(iv) the semantic analysis module configured to semantically analyze and rank the data received from the qualitative assessment module to generate a qualitative score for the artist, and then communicate the qualitative score for the artist to the score processor,
wherein the score processor is configured to select weightings for each of the quantitative score for the artist and the qualitative score for the artist, and then combine the weighted qualitative and quantitative scores into a final artist score for each artist,
(v) a score transmission module in communication with the score processor, the score transmission module configured to transmit the final score for each artist over the network to the artist, and to transmit the final scores for the plurality of artists to each of the plurality of artist promoter computer systems, and
wherein the plurality of artist promoter computer systems are each configured to direct resources to the plurality of artists in relation to the final artist scores for each artist.

20. The computer system of claim 19, wherein the audience member computer systems are smartphones, and data is input through smartphone apps.

21. The computer system of claim 19, wherein the data received by the quantitative assessment module comprises one or more of: (i) presence metrics, (ii) product metrics, (iii) popularity metrics, (iv) productivity metrics, or (iv) profitability metrics.

22. The computer system of claim 19, wherein the data received by the qualitative assessment module comprises one or more of: (i) presence metrics; (ii) product metrics; or (iii) popularity metrics.

23. The computer system of claim 19, wherein the plurality of artist promoter computer systems are each configured to post commentary to websites to accessible to the audience member computer systems over the network to: (i) increase the frequency of the artist's performances as compared to artists having lower final score rankings, (ii) increase media discussion associated with promotion of the artist as compared to artists having lower final score rankings, or (iii) increase the number of audience members who are invited to attend or view or listen to the artist's performances.
